(19) United States
(12) Patent Application Publication
(10) Pub. No.: US 2006/0121424 A1
(43) Pub. Date: Jun. 8, 2006

(54) System and Method for Handwriting Instruction

(75) Inventors: Amy N. Ford, Cincinnati, OH (US); Sherry F. Willbrand, Cincinnati, OH (US)

Correspondence Address: LAFKAS PATENT LLC, 7811 LAUREL AVENUE, CINCINNATI, OH, 45243, US

(73) Assignee: WRITE-ON HANDWRITING, LLC, Cincinnati, OH (US)

(21) Appl. No.: 10/904,954

(22) Filed: Dec. 7, 2004

(51) Int. Cl. G09B 19/00

(52) U.S. Cl. 434/236

(57) ABSTRACT

A method and system for teaching, evaluating and reporting handwriting abilities by demonstrating sequential formation of symbols, allowing an individual to re-create the sequential formation of the symbols, continuous evaluation of the sequential formation of the symbols by the individual, providing positive reinforcement and a summary report of the handwriting abilities of the individual.

### BACKGROUND

The present invention relates to a system and method for teaching handwriting. More particularly, the present invention relates to a means of teaching handwriting that provides multiple examples of handwriting development along with real-time correction arising from handwriting errors.

The prevalence of personal computers over the last decade or two has resulted in what some educators believe is a decrease in the value of proper and legible handwriting abilities on the part of not only current individuals, but also graduates from the educational institutions. As the use of personal computers increased, a trend towards typing more than manually writing words, notes, letters and papers was seen. Recently, however, there has been a reverse trend in academia to see a greater value in teaching and developing proper manual handwriting skills, especially at a younger age.

Support for increasing the teaching of handwriting skills results from a fundamental problem in education fields, namely, difficulty in reading an individual's answers on schoolwork and standardized examinations. For example, more and more standardize tests involve some sort of written response by individuals, and often computers and typing are not permitted. In such situations, the individuals must manually write a response that is not read by the individual's teacher, who may be familiar with the particular individual's handwriting idiosyncrasies. Instead, an anonymous grader will review the individual's response, and if the anonymous grader has to struggle to interpret an individual's handwritten response, the individual's grade will likely detrimentally decrease.

It is estimated that students in elementary schools may spend between about 31% and about 60% of each academic day on fine motor skills, including handwriting. As most students do not have access to individual computers during the entire academic day, handwriting is the default and primary means by which the students communicate and display what has been learned. Some studies have shown a correlation between legibility of handwriting and increased grades given to students, no matter what the level of education.

It has also been theorized and shown that students who have been provided handwriting lessons tend to produce grammatical sentences more articulately than students not given such handwriting lessons. Some experts suggest handwriting lessons increase the students' grammatical prowess because if a student must stop or slow her thoughts to consider how to form a particular letter, there is an increased likelihood the student will lose ideas to be conveyed from their working memory.

To this end, and to bridge the gap between technology and, for example, manual handwriting skills, several national teaching organizations including, for example, The National Board for Teaching Professional Teaching Standards (NBPTS), the International Society for Teaching in Education (ISTE) and the National Educational Technology Standards (NETS) Project have joined forces to encourage the development of electronic learning environments where teaching resources and collaboration can occur. Thus far, manual handwriting and technology have not merged in a highly effective manner.

Over the years, various types and formats of teaching manual handwriting skills have developed and have been presented. For example, a basic and possibly most familiar means of teaching manual handwriting skills involved a book of worksheets having the letters of the English language presented. An individual would presumably then take a piece of paper and place it over a page of the worksheet and trace the letters of the English language presented in the worksheets. Presumably, the individual learns the correct shape of the English language letters by repetitive examples. However, often such workbooks do not present the steps involved with developing each individual letter, and do not provide much feedback to an observing teacher about the individual's handwriting development short of the individual's ability to trace.

With the advent of widespread use of personal computers, programs were created to assist in teaching proper handwriting techniques. However, many such programs were concerned more with the actual manifestation of the handwriting strokes by the individual. That is, for example, the programs determined whether an individual used too much force in creating a letter, whether the tilt angle of the pen being manipulated by the individual was acceptable, whether the acceleration and deceleration by the individual was within a predetermined acceptable numeric range, and whether “inappropriate” lifting of the writing instrument by the individual occurred. Typically, though, such programs overlooked the basic problem of teaching individuals the proper sequence of steps to write a letter or number.

Ultimately, though, current handwriting methods and programs fail to account for a single teacher's ability to be able to assess each individual in a classroom, some of which classrooms are having larger and larger individual to teacher ratios.

Thus, what is needed is a method and system for teaching basic manual handwriting skills in such a way that can be reviewed by a teacher in a timely and effective manner while also providing immediate assistance to individuals when needed.

### SUMMARY

The various exemplary embodiments of the present invention include a method of teaching and evaluating sequential formation of one or more symbols by an individual via a computer. The method comprises demonstrating sequential formation of the one or more symbols via the computer. The demonstrating preferably occurs one to five times. The method further comprises prompting the individual to re-create the one or more symbols in a substantially similar sequential formation as demonstrated. According to the exemplary method, the individual creates the one or more symbols on the computer via an input device, and the sequential formation of the one or more symbols as created by the individual is analyzed in substantially real time. Substantially real time correction is supplied to the individual if the sequential formation of the one or more symbols by the individual is not substantially similar to the sequential formation as demonstrated via the computer. The individual is rewarded for substantially re-creating sequential formation of the one or more symbols as demonstrated via the computer, and a summary report indicating the successfully re-created one or more symbols is supplied.

The various exemplary embodiments of the present invention further comprises a system for teaching and evaluating sequential formation of one or more symbols by an individual. The system includes a computer comprising an input device, a demonstration module, an analyzation module, and a rewarding module. The demonstration module presents the sequential formation of the one or more symbols in a predetermined number of times. The analyzation module examines, in real time, the sequential formation of the one or more symbols by the individual, and provides real time correction should the individual improperly re-create the one or more symbols. The rewarding module provides positive reinforcement to the individual and develops a summary report indicating that the individual has mastered the one or more symbols demonstrated by the system.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a screenshot of a computer program according to the exemplary embodiments of the present invention.

FIG. 2 is another exemplary screenshot of a computer program showing successful re-creation of one or more symbols according to the exemplary embodiments of the present invention.

FIG. 3 is a screenshot of a computer program showing a summary report according to the exemplary embodiments of the present invention.

FIG. 4 is a flowchart of an exemplary embodiment of the present invention.

### DETAILED DESCRIPTION

The exemplary embodiments of the present invention include a method and system for teaching and evaluating formation of one or more symbols by an individual.

As used herein, “symbols” is defined as any one or more letters of any known language, one or more numbers, one or more mathematical symbols, one or more geometric shapes, one or more predetermined designs, and combinations thereof. The one or more letters may be in any predetermined font, block or cursive style.

“Individual” as used herein is defined as any person in a position to learn, re-learn or improve the sequential formation of one or more symbols. Individual may include those persons overcoming physical impairments or injuries via occupational therapy resources.

“Computer” as used herein includes any personal or commercial electronic hardware on which the present invention may be viewed, employed, or both. Examples include, but are not limited to, desktop computers, laptop computers, handheld devices, personal data assistants, mobile telephones, interactive whiteboards, and whiteboard captures systems.

In various exemplary embodiments of the present invention, a demonstration of sequential formation of the one or more symbols is provided to the individual.

“Sequential formation” as used herein is defined as the progressive steps or stages of creation of the one or more symbols of interest.

The demonstration of the sequential formation of the one or more symbols according to various exemplary embodiments may comprise one or more instructional means. Examples of instructional means by which the demonstration is presented include audio instruction, written instruction and guided instruction.

Audio instruction may comprise a computer program that states the sequential formation of one or more symbols via a speaker system of a computer. The audio instruction is tailored to each individual symbol being taught and demonstrated to the individual.

For example, in demonstrating the sequential formation of a lower case English letter “t,” the audio instructions may state to “Start on the top line and dive down to the writing line. Stop drawing at the writing line. Pick up your pencil and move it to the mid line to the left of the line previously created with your pencil. Press your pencil down and move to the right along the mid line to cross the line previously created with your pencil.”

Audio instruction may further comprise a teacher reading instructions from a workbook to an individual.

Written instruction may comprise of textual instructions of the sequential formation of the one or more symbols. The written instruction is tailored to each individual symbol being taught and demonstrated to the individual.

In a preferred embodiment, the written instruction is simple language visible on the medium on which the one or more symbols are demonstrated to the individual. In another preferred embodiment, the written instruction corresponds to the audio instruction when both are present.

Guided instruction according to the various exemplary embodiments of the present invention comprises a visual step-by-step presentation of the sequential formation of the one or more symbols. In the embodiments in which the individual is using a computer, the visual step-by-step presentation of the sequential formation of the one or more symbols is preferably a substantially continuous example showing lines of the one or more symbols being drawn. The guided instruction may include an animation showing the sequential formation of the one or more symbols.

In various embodiments comprising the guided instruction according to the present invention, one or more arrows instruct the direction of sequential formation of lines of the one or more symbols to be produced.

In a preferred embodiment of the present invention, when using a computer, such one or more arrows instructing the direction of sequential formation of lines of the one or more symbols decrease in visibility as the individual masters the sequential formation of the particular one or more symbols.

For example, the first time an individual is prompted to re-create one or more particular symbols, the arrows guiding the direction the individual should draw the one or more symbols may be clearly defined and fully visible. As the individual successfully re-creates the one or more particular symbols, the arrows progressively fade into the background with each successful re-creation.

In a preferred example, the arrows eventually disappear from visibility after a predetermined number of successful re-creations of one or more particular symbols.

In various embodiments comprising the guided instruction according to the present invention, the one or more symbols to be re-created is visible in a space where the individual should re-create the one or more symbols. In this way, the student may essentially trace the one or more symbols in initial attempts to re-create the one or more symbols.

In a preferred embodiment of the present invention, when using a computer, such visible one or more symbols to be re-created decreases in visibility as the individual masters the sequential formation of the particular one or more symbols.

In a preferred example, the one or more symbols to be re-created eventually disappears from visibility after a predetermined number of successful re-creations of one or more particular symbols.

In the various exemplary embodiments of the present invention, a starting point for re-creation of the one or more symbols is identified to the individual as an icon such as, for example, a star. The icon assists the individual in recalling the point as to where to re-create the one or more symbols. The icon may decrease in visibility as the student successfully re-creates the one or more symbols.

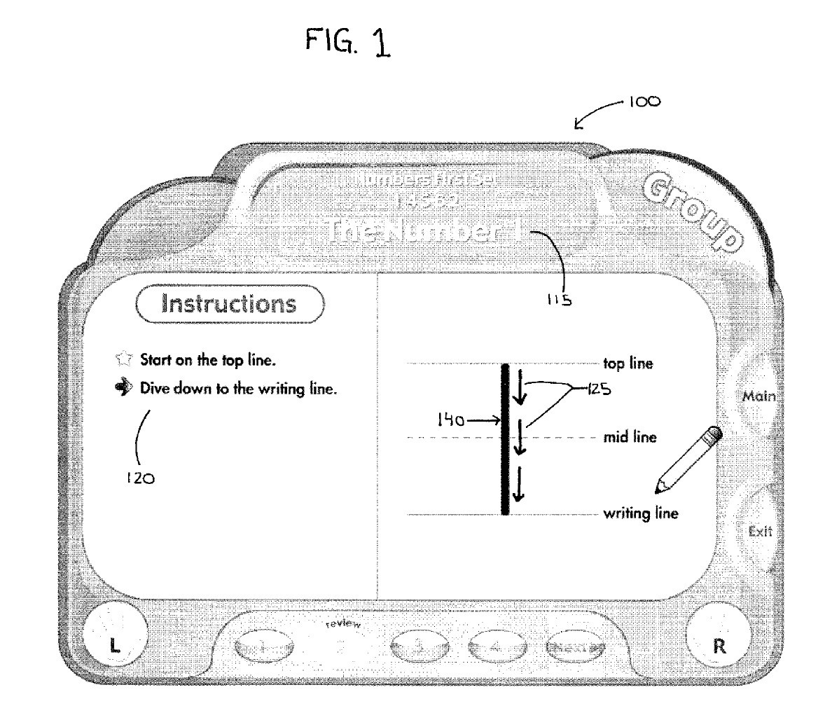

FIG. 1 is an illustrated example of a computer screenshot 100 according to the present invention. In the screenshot 100, a title bar 115 identifies to the individual the one or more symbols that the individual is learning to re-create. Written instructions 120 are presented to the individual in this example. The individual is also provided with guided instructions in the form of arrows 125 showing the direction in which the individual should manipulate an input device (not shown) in order to properly re-create the one or more symbols. The manifestation of manipulation of the input device by the individual is shown on the screen as symbol formation 140.

In exemplary embodiments of the present invention, the individual is prompted to re-create the one or more symbols demonstrated.

Prompting the individual to re-create the one or more symbols comprises an audio prompt, a written prompt, an instructional prompt, or combinations thereof.

An audio prompt may comprise spoken instructions, predetermined sound, or a combination such that the individual recognizes that the demonstration is complete and the individual is being prompted to re-create the one or more symbols.

A written prompt may comprise a set of one or more visually readable texts giving directions to the individual to re-create the one or more symbols just shown.

An instructional prompt may comprise of a design or animation that provides directions to the individual to begin re-creating the one or more symbols. For example, a cartoon pencil may appear at a point at which the individual should begin to re-create the one or more symbols.

When prompted to re-create the one or more symbols, the individual may re-create the one or more symbols via an input device.

In the various exemplary embodiments, the input device of the present invention comprises a stylus, a mouse, a touch pad, a touch screen, and combinations thereof.

In the various exemplary embodiments of the present invention, re-creation of the one or more symbols by the individual is analyzed in substantially real-time. The substantially real-time analyzation examines the sequential formation of the one or more symbols.

If the re-creation of the one or more symbols by the individual does not substantially mimic the sequential formation as presented to the individual, a substantially real-time correction will be supplied to the individual.

In the various exemplary embodiments, the substantially real-time correction may comprise of an audible alarm indicating to the individual that there is an error in the re-creation of the one or more symbols. Such an audible alarm may include, for example, a beep, a recorded human voice, or any other predetermined sound.

The substantially real-time correction according to the various exemplary embodiments may comprise of a visual error means. The visual error means may include, for example, flashing colors, a pop-up window indicating an error in the re-creation, an animation, an inability to continue re-creating the one or more symbols, or a combination thereof.

Should the individual substantially re-create the one or more symbols without a real-time correction, the individual is rewarded. A reward may comprise an audio, written or visual positive reinforcement for successful re-creation of the one or more symbols. The reward may be, for example, an animated smiley face, a recorded voice stating “Good job!” or a pop-up window with the written words “You did it!”

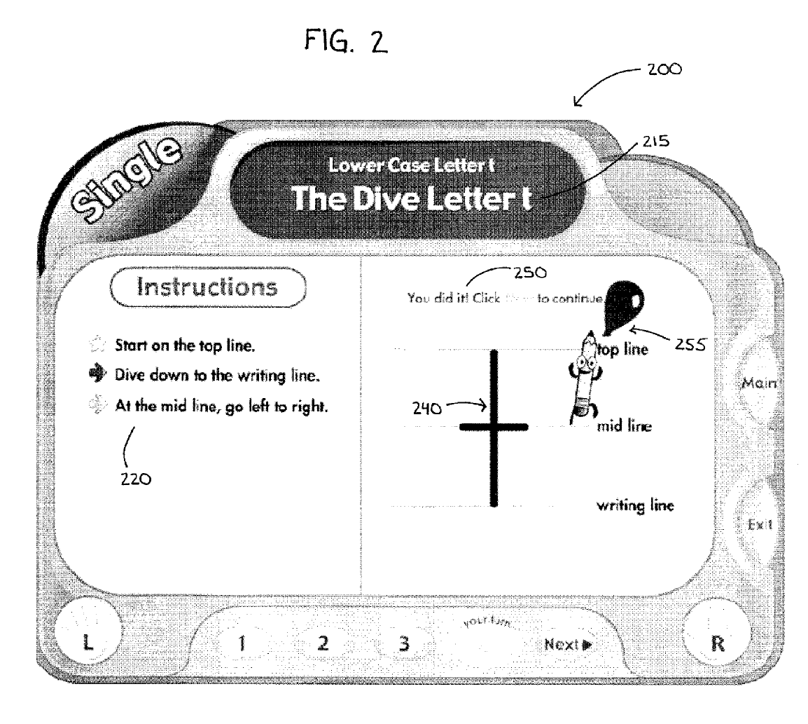

FIG. 2 is an illustrated example of a screenshot 200 showing successful re-creation by an individual of one or more symbols. The screenshot 200 comprises a title bar 215 indicating the one or more symbols meant to be re-created by the individual. Written instructions 220 are visible to the individual at anytime in this example. Successful formation of the one or more symbols, here the lowercase letter “t,” is represented on the screen as symbol formation 240. Rewards are shown as written reward 250 and animated reward 255.

Upon successful re-creation of the one or more symbols, the individual may be guided through the process of recreating the same one or more symbols an addition one or more times. Preferably, the individual successfully re-creates the same one or more symbols four times consecutively before recreating one or more different symbols.

In a preferred embodiment, the individual is not permitted to skip recreating one or more particular symbols until the individual has not successfully completed the particular one or more symbols at least twice consecutively. This is to encourage the individual to at least attempt recreating the one or more particular symbols, while also trying to avoid the individual from getting frustrated on the one or more particular symbols.

According to various exemplary embodiments, the one or more symbols are presented to the individual for re-creation in a predetermined pattern. A predetermined pattern may, for example, be groups of one or more symbols that have similar shapes and sequential formation that allows the individuals to build confidence in abilities as well as have a better understanding of the relatedness of characteristics of the one or more symbols.

For example, an individual may be prompted to re-create a lowercase block letter “c.” The next letter the individual learns may be a lowercase block letter “a,” which would begin with recreating the previously re-created letter “c” and then extending the movement to include a line to close the loop of the “c.” After mastering the “a,” the individual may be prompted to re-create a lowercase block letter “d” as an extension of the movement of the lowercase block letter “a,” and so on.

In various exemplary embodiments, a summary report may be generated based on the re-creation abilities of the individual. The summary report may, for example, display the number of substantially real-time corrections for the individual, the number and particular one or more symbols mastered by the individual, the number and particular one or more symbols skipped by the individual, and examples of the re-creation abilities of the individual.

The summary report may be a hard copy or be electronic. The summary report may be used by a teacher, tutor, parent or therapist to evaluate the progress of an individual's handwriting abilities.

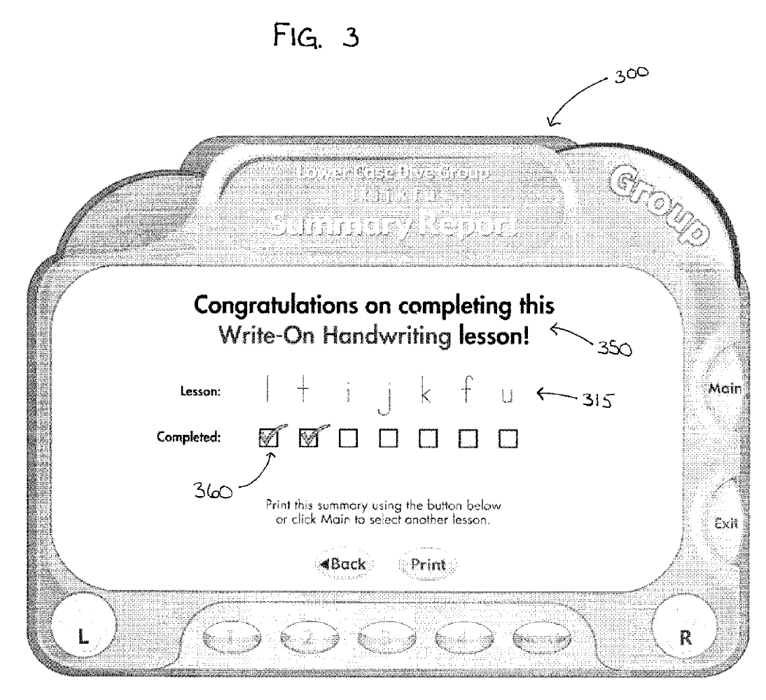

FIG. 3 is an illustrated example of screenshot 300 of a summary report according to the various exemplary embodiments of the present invention. The summary report indicates the one or more symbols 315 meant to be re-created by the individual and a symbolic grade 360 as to the abilities of the individual to re-create the one or more symbols. The symbolic grade may be a numerical grade, a letter grade, or as in this example, a grade involving a mark. The summary report of FIG. 3 also includes a written grade 350.

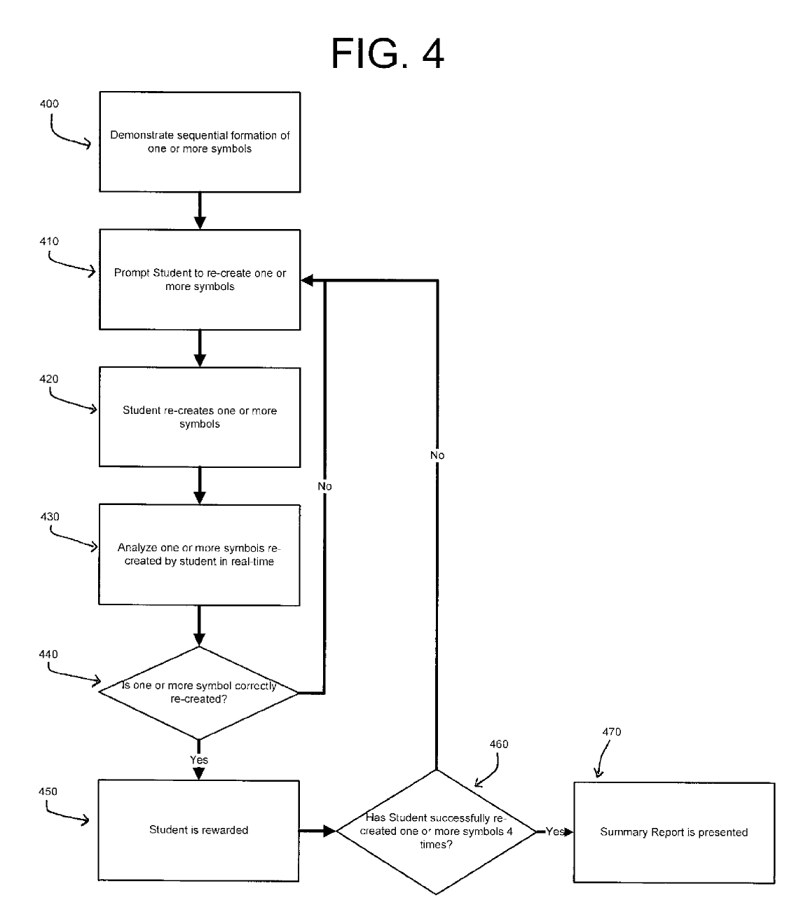

FIG. 4 is a flowchart setting forth the basic steps according to various exemplary embodiments of the present invention. In the flowchart, the sequential formation of one or more symbols is demonstrated to an individual. See step 400. Next, the individual is prompted to re-create the same one or more symbols as demonstrated. See step 410. In step 420, the individual re-creates the same one or more symbols. Meanwhile, the individual's re-creation of the one or more symbols is analyzed in real-time. See step 430. As the one or more symbols' re-creation is analyzed, it is determined whether or not the re-creation is being done correctly. See step 440. If the re-creation of the one or more symbols by the individual is not correct, the individual will be prompted to again re-create the one or more symbols. If the re-created of the one or more symbols by the individual is correct, the individual is rewarded. See step 450. In step 460, the number of correct re-creations of the same one or more symbols is examined. If the individual has not successfully re-created the one or more symbols at a predetermined number of times, here the example is four times, then the individual is prompted to again re-create the one or more symbols correctly. If the individual has successfully re-created the one or more symbols at a predetermined number or times, a summary report is created. See step 470. The summary report may identify any deficiencies or problems that the individual had in re-creating any particular one or more symbols.

The various exemplary embodiments of the present invention further comprise a system for teaching, analyzing and reporting handwriting abilities of an individual. The system is preferably a computer comprising an input device that can be manipulated by an individual in a means similar to manipulation of a writing instrument such as, for example, a pencil or pen.

The various exemplary embodiments of the present invention preferably teach correct formation of letters, numbers and symbols. The present invention teaches via a multi-sensory approach to better enhance learning and memory. Various exemplary embodiments of the present invention may further comprise a traditional paper workbook to allow teachers a better opportunity to observe a student's grip on a writing instrument, such as, form example, a pen, pencil or stylus. One of the most essential components of handwriting is not whether a student holds the writing instrument properly, but rather it is whether the student knows how to write the particular letter, number or symbol properly. A student with a great pencil grip may still not know how to write a particular letter, number or symbol, and thus written expression is slow, laborious and lacking ideation.

The system according the various exemplary embodiments comprises a demonstration module, an analyzation module and reporting module. The demonstration module sets forth to the individual the sequential formation of one or more symbols. The demonstration module may present the sequential formation via written instructions, auditory instructions, animated guided instructions, and combinations thereof. The sequential formation may be present from one to five times by the demonstration module.

After the demonstration module has presented the sequential formation of the one or more symbols in a predetermined number of times, the individual manipulates the input device to re-create the sequential formation of the one or more symbols presented by the demonstration module.

As the individual manipulates the input device, the analyzation module of the system examines the sequential formation of the one or more symbols by the individual. The analyzation module preferably examines the sequential formation in real time.

Should the analyzation module determine that the sequential formation of the one or more symbols on the part of the individual not be correct, the analyzation module supplies substantially immediate correction to the individual. Immediate correction on the part of the analyzation module may, for example, be in the form of prompting the individual to begin re-creation of the one or more symbols again. For example, the analyzation module may also set forth to the individual via written, audio or animated correction what the individual did incorrectly in re-creating the one or more symbols.

If the individual properly re-creates the one or more symbols in a predetermined number of times, the reporting module provides positive reinforcement to the individual and develops a summary report indicating that the individual has mastered the one or more particular symbols. The reporting module may then communicate to the demonstration module that the one or more particular symbols has been mastered and that the individual is ready for a new one or more symbols.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A method of teaching and evaluating sequential formation of one or more symbols by an individual via a computer, comprising:
demonstrating sequential formation or the one or more symbols via the computer, wherein the demonstrating occurs one to five times;
prompting the individual to re-create the one or more symbols in a substantially similar sequential formation as demonstrated;
creating the one or more symbols by the individual on the computer via an input device;
analyzing the sequential formation of the one or more symbols as created by the individual, wherein the analyzing occurs in substantially real time;
supplying substantially real time correction to the individual if the sequential formation of the one or more symbols by the individual is not substantially similar to the sequential formation as demonstrated via the computer;
rewarding the individual for substantially re-creating sequential formation of the one or more symbols as demonstrated via the computer; and
supplying a summary report.

2. The method according to claim 1, wherein the demonstrating sequential formation of the one or more symbols via the computer comprises written instructions, auditory instructions, visual instructions, animated instructions, guided instructions, or combinations thereof.

3. The method according to claim 2, wherein the guided instructions comprise one or more sets of arrows directing the individual in the proper sequence formation of the one or more symbols, a representation of the one or more symbols to be re-created, an icon indicating a starting point for proper sequence formation of the one or more symbols, or a combination thereof.

4. The method according to claim 2, wherein the guided instructions become progressively less visible as the individual successfully re-creates the sequence formation of the one or more symbols.

5. The method according to claim 1, wherein the one or more symbols are letters, numbers, mathematical symbols, geometric shapes, designs, or combinations thereof.

6. The method according to claim 5, wherein the letters are block letters, cursive, or combination thereof.

7. The method according to claim 1, wherein the demonstrating is repeated one to five times before the individual is prompted to re-create the one or more symbols.

8. The method according to claim 1, wherein the prompting, creating, analyzing, supplying and rewarding are repeated one to five times.

9. The method according to claim 1, wherein the input device is a stylus, a mouse, a touch pad, a touch screen or combination thereof.

10. The method according to claim 1, wherein the real time correction is a written message, a predetermined audio message, or a combination thereof.

11. The method according to claim 1, wherein the summary report indicates the ability of the individual to re-create the one or more symbols as demonstrated.

12. A system for teaching and evaluating sequential formation of one or more symbols by an individual, comprising:
a computer comprising:
an input device;
a demonstration module; wherein the demonstration module presents the sequential formation of the one or more symbols in a predetermined number of times
an analyzation module, wherein the analyzation module examines, in real time, the sequential formation of the one or more symbols by the individual, and provides real time correction should the individual improperly re-create the one or more symbols; and
a rewarding module, wherein the rewarding module provides positive reinforcement to the individual and develops a summary report indicating the abilities of the individual in re-creating the one or more symbols demonstrated by the system.

13. The system according to claim 12, wherein the one or more symbols are letters, numbers, mathematical symbols, geometric shapes, designs, or combinations thereof.

14. The system according to claim 12, wherein the input device is a stylus, a mouse, a touch pad, a touch screen or combination thereof.

15. The system according to claim 12, wherein the demonstration module presents sequential formation of the one or more symbols in the form of written instructions, auditory instructions, guided instructions, or combinations thereof.

16. The system according to claim 1 5, wherein the guided instructions comprise one or more sets of arrows directing the individual in the proper sequence formation of the one or more symbols, a representation of the one or more symbols to be re-created, an icon indicating a starting point for proper sequence formation of the one or more symbols, or a combination thereof.

17. The system according to claim 15, wherein the guided instructions become progressively less visible as the individual successfully re-creates the sequence formation of the one or more symbols.

18. The system according to claim 12, wherein the demonstration module demonstrates the sequential formation of the one or more symbols is repeated one to five times before the individual is prompted to re-create the one or more symbols.

19. The system according to claim 12, wherein the real time correction provided by the analyzation module is a written message, a predetermined audio message, or a combination thereof.

20. The system according to claim 12, wherein the rewarding module provides the summary report after the individual has successfully re-created the one or more symbols at least three times.
